(19) United States
(12) Patent Application Publication
(10) Pub. No.: US 2025/0079780 A1
(43) Pub. Date: Mar. 6, 2025

(54) SINGLE PIECE CAT 6/6A PLUGS

(71) Applicant: Panduit Corp., Tinley Park, IL (US)

(72) Inventors: Robert E. Fransen, Orland Park, IL (US); Roman J. Churnovic, Manhattan, IL (US)

(73) Assignee: Panduit Corp., Tinley Park, IL (US)

(21) Appl. No.: 18/238,789

(22) Filed: Aug. 28, 2023

(51) Int. Cl. H01R 24/64; H01R 13/58

(52) U.S. Cl. CPC H01R 24/64; H01R 13/58

(57) ABSTRACT

An RJ45 plug assembly has a housing and a communications cable to be inserted within. The communications cable has a plurality of twisted pairs of conductors. The housing has a plurality of sloped surfaces such that when conductors of the communications cable are straightened and aligned prior to insertion into the housing, the sloped surfaces route a first pair of conductors to a top of the housing and a second pair of conductors to a bottom of the housing.

### FIELD OF INVENTION

The present invention relates generally to the field of RJ45 plugs and more specifically to an RJ45 plug with a reduced number of parts to facilitate the termination process.

### BACKGROUND

Companies are continuously looking for opportunities to improve RJ45 plugs by finding ways to make them easier and faster to terminate, reduce the overall number of pieces, and decrease manufacturing costs. RJ45 plugs typically feature multiple small pieces, and they are difficult to handle. U.S. Pat. No. 6,811,445 explains key features of these designs in detail. The piece part and labor costs associated with the plug assembly are a major portion of total patch cord costs. As such, there is a need for a reduced piece Cat6/6A plug design that allows for easier and faster termination, which also lends itself to automated assembly.

### SUMMARY

An RJ45 plug assembly has a housing and a communications cable to be inserted within. The communications cable has a plurality of twisted pairs of conductors. The housing has a plurality of sloped surfaces such that when conductors of the communications cable are straightened and aligned prior to insertion into the housing, the sloped surfaces route a first pair of conductors to a top of the housing and a second pair of conductors to a bottom of the housing.

### BRIEF DESCRIPTION OF THE DRAWINGS

FIG. 1 is a front isometric view of communication system 10.

FIG. 2 is an isometric view of end “B” of cable 26 prior to termination to cable end “B” plug assembly 16.

FIG. 3 is an isometric view of end “A” of cable 28 prior to termination to cable end “A” plug assembly 18.

FIG. 4 is an isometric exploded view of cable end “B” plug assembly 16 and cable 26 for a first embodiment of the present invention (the first embodiment is reflected in FIGS. 4-12).

FIG. 5 is a rear view of cable end “B” plug housing 20.

FIG. 6 is a top view of cable 26 prior to termination to cable end “B” plug assembly 16 where conductor pairs 24 have been arranged in sequence and trimmed to length.

FIG. 7 is a top view of cable end “B” plug housing 20.

FIG. 8 is a top view of end “B” of cable 26 terminated to cable end “B” plug assembly 16.

FIG. 9 is a section view of end “B” of cable 26 terminated to cable end “B” plug assembly 16 taken about line A-A in FIG. 8.

FIG. 10 is an isometric exploded view of cable end “A” plug assembly 18 and cable 28.

FIG. 11 is a rear view of cable end “A” plug housing 22.

FIG. 12 is a top view of cable 28 prior to termination to cable end “A” plug assembly 18 where conductor pairs 24 have been arranged in sequence and trimmed to length.

FIG. 13 is an isometric view of cable end “B” shielded plug assembly 60 and cable end “A” shielded plug assembly 62 for a second embodiment of the present invention (the second embodiment is reflected in FIG. 13-17).

FIG. 14 is a rotated isometric view of cable end “B” shielded plug assembly 60 and cable end “A” shielded plug assembly 62.

FIG. 15 is a rear view of cable end “B” shielded plug housing 64 and cable end “A” shielded plug housing 66.

FIG. 16 is an exploded view of cable end “B” shielded plug assembly 60 and cable end “A” shielded plug assembly 62.

FIG. 17 is a rotated exploded view of cable end “B” shielded plug assembly 60 and cable end “A” shielded plug assembly 62.

### DESCRIPTION OF INVENTION

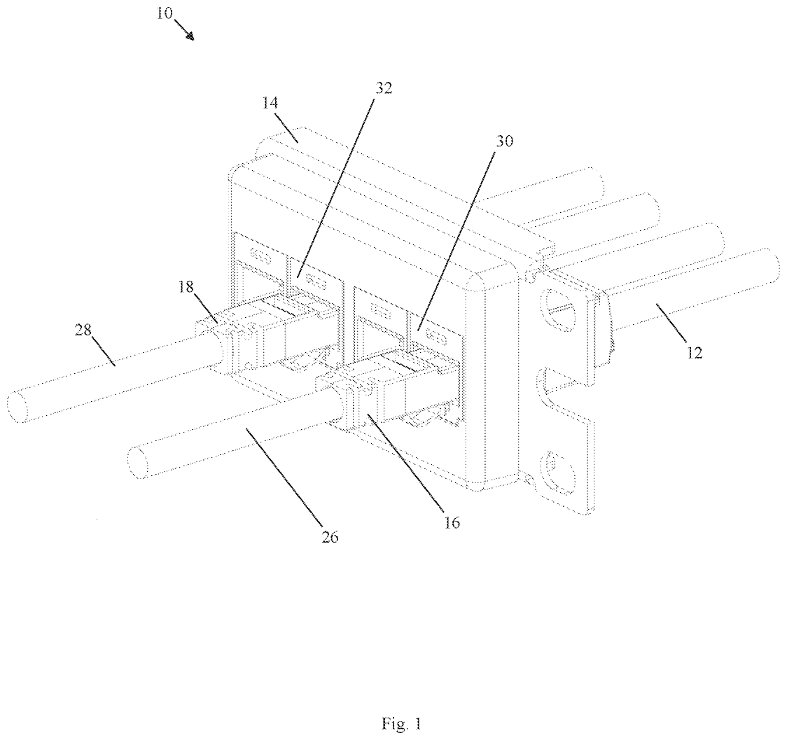

FIG. 1 is a front isometric view of communication system 10 which includes cable end “B” plug assembly 16, cable 26, cable end “A” plug assembly 18, cable 28, and communication cables 12 connected to equipment 14 via jack 30 and jack 32. Equipment 14 is illustrated as a patch panel in FIG. 1, but the equipment can either be passive equipment or active equipment. Examples of passive equipment can be, but are not limited to, modular patch panels, punch down patch panels, coupler patch panels, wall jacks, etc. Examples of active equipment can be, but are not limited to, Ethernet switches, routers, servers, physical layer management systems, and power-over Ethernet (POE) equipment found in data centers and/or telecommunication rooms; security devices (cameras and other sensors, etc.) and door access equipment; and telephone, computers, fax machines, printers, and other workstation peripherals. Communication system 10 can further include cabinets, racks, cable management and overhead routing systems and other such equipment. Cable end “B” plug assembly 16 is terminated to cable 26 and mates with respective jack 30 in equipment 14. Cable end “A” plug assembly 18 is terminated to cable 28 and mates with respective jack 32 in equipment 14. Although jack 30 and jack 32 are shown as modular jacks, they can be punch down jacks or other types of jacks.

In the four-pair copper connector industry it is well known that the configuration of conductor pairs 24 on each end of a cable will differ. In this example, end “B” will refer to the configuration in which conductor pair 24₄₋₅ is on the top, and end “A” will refer to the configuration in which conductor pair 24₃₋₆ is on top. Conductor pairs 24 subscript denotes conductor numbers. All disclosed artwork is shown with cables routed to TIA 568B with the understanding that a person knowledgeable in the plug termination field recognizes that the TIA 568A wiring scheme can be achieved by rearranging the order of certain conductor pairs 24₁₋₂ and 24₃₋₆.

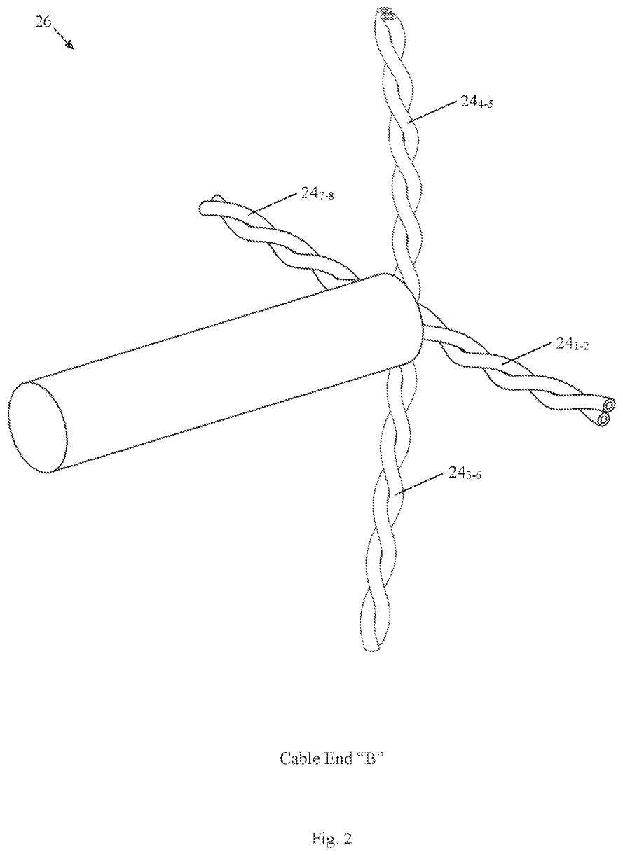

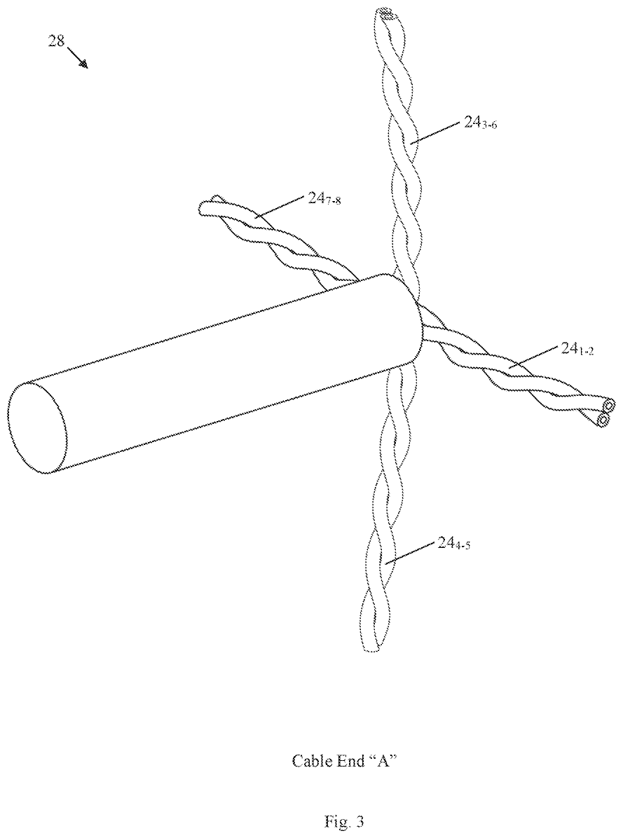

FIG. 2 is an isometric view of end “B” of cable 26 prior to termination to cable end “B” plug assembly 16. FIG. 3 is an isometric view of end “A” of cable 28 prior to termination to cable end “A” plug assembly 18.

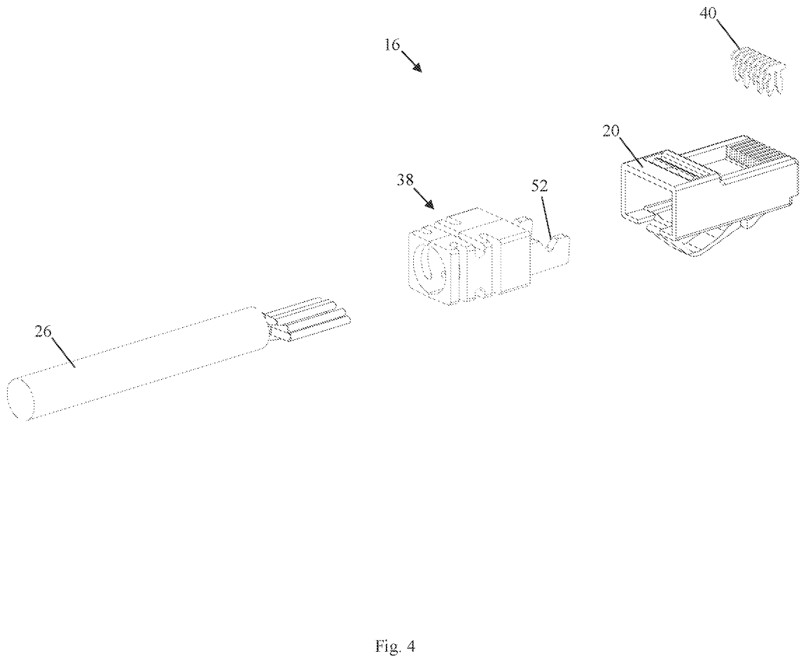

FIG. 4 is an isometric exploded view of cable end “B” plug assembly 16 and cable 26. Cable end “B” plug assembly 16 includes cable end “B” plug housing 20, boot 38, and insulation piercing contacts (IPCs) 40. Boot 38 is not necessary to the functionality of cable end “B” plug assembly 16, but it can be utilized by customers for added strain relief and bend radius control.

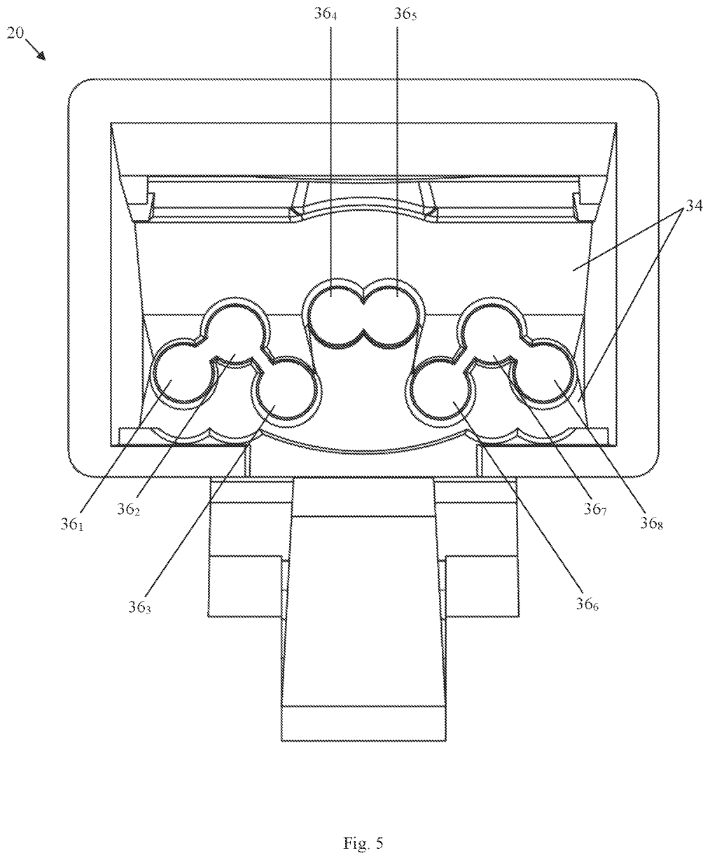

FIG. 5 is a rear view of cable end “B” plug housing 20. Cable end “B” plug housing 20 is designed to separate conductor pairs 24 without the use of additional components. Sloped surfaces 34 guide conductor pairs 24 to their respective tunnels 36 prior to termination. Tunnels 36 are oriented such that conductor pair 24₄₋₅ will route to the top and conductor pair 2436 will route to the bottom. Tunnels 36 subscript denotes conductor numbers. This orientation of tunnels 36 allows for no crossed conductor pairs 24 when terminating end “B” of cable 26, which aids in electrical performance. For conductor pairs 24 to route to their correlating tunnels 36, conductor pairs 24 need to be prepared and trimmed prior to insertion into cable end “B” plug housing 20.

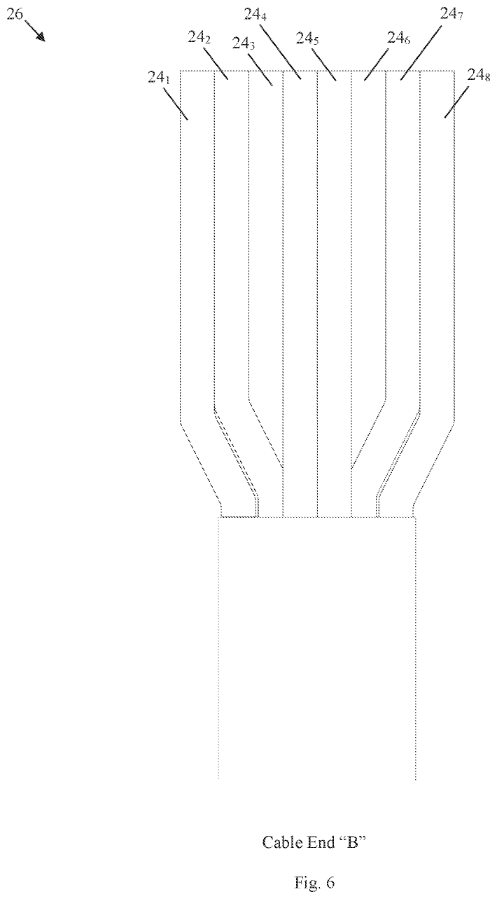

FIG. 6 is a top view of cable 26 prior to termination to cable end “B” plug assembly 16 where conductor pairs 24 have been arranged in sequence and trimmed to length.

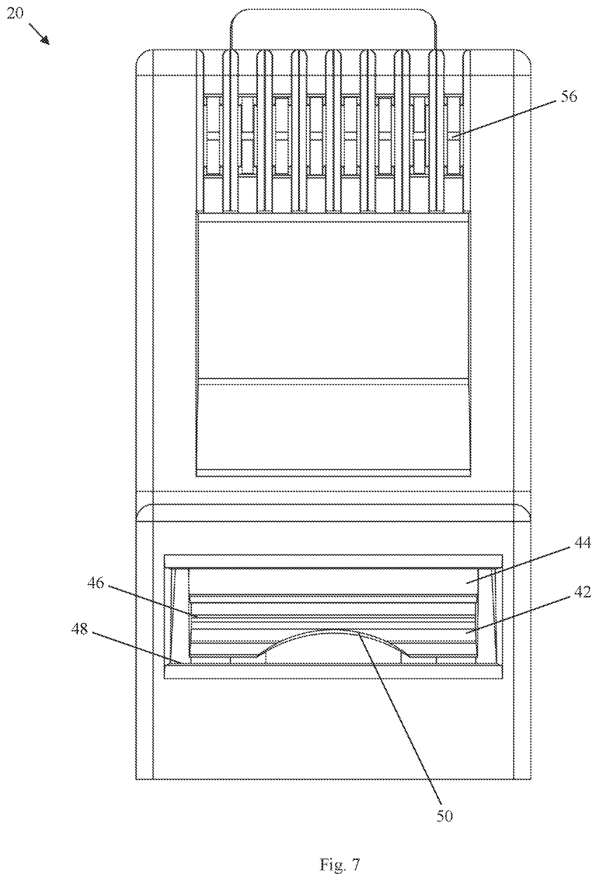

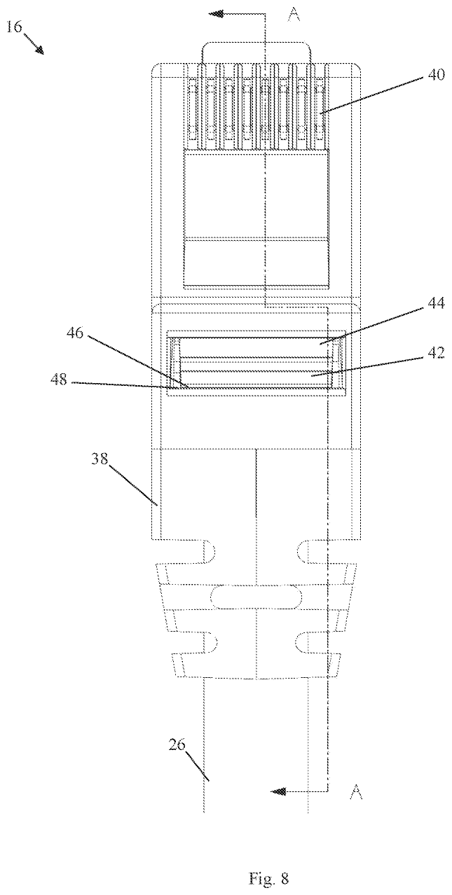

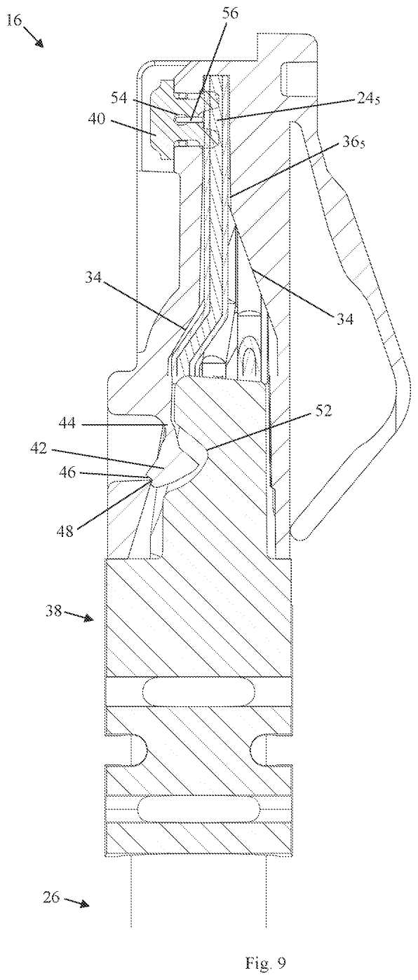

FIG. 7 is a top view of cable end “B” plug housing 20. FIG. 8 is a top view of end “B” of cable 26 terminated to cable end “B” plug assembly 16. FIG. 9 is a section view of end “B” of cable 26 terminated to cable end “B” plug assembly 16 taken about line A-A in FIG. 8. During the plug termination process, strain relief feature 42 on cable end “B” plug housing 20 rotates about living hinge 44 until catch 46 stops on edge 48 which secures strain relief feature 42 and traps cable 26 into cable end “B” plug assembly 16. Recess 50 (FIG. 7) on strain relief feature 42 is designed to accommodate the larger cable diameter of cable 26 to ensure enough pressure is applied to prevent removal of cable 26 after termination while still allowing strain relief feature 42 to rotate into its final position. Notch 52 on boot 38 is designed to engage with strain relief feature 42 as it is rotated into its final position during the termination process to prevent the removal of boot 38 from cable end “B” plug assembly 16. Cable end “A” plug housing 22 has a strain relief geometry identical to cable end “B” plug housing 20. IPCs 40 are designed with slots 54 to enable easy termination to both solid and stranded conductors. Support ribs 56 in cable end “B” plug housing 20 and cable end “A” plug housing 22 give added stability to IPCs 40 during the termination process by preventing IPCs 40 from rocking or rotating. The functionality of IPCs 40 is described in further detail in U.S. Pat. No. 9,640,924.

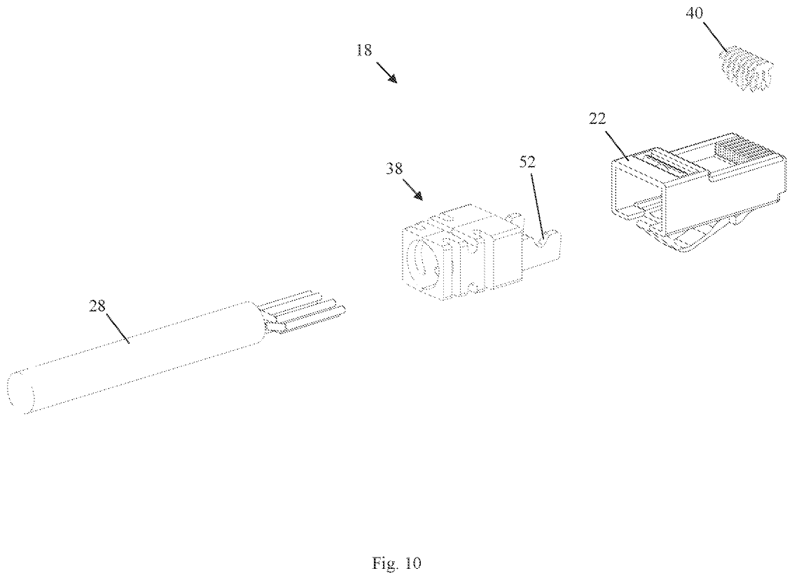

FIG. 10 is an isometric exploded view of cable end “A” plug assembly 18 and cable 28. Cable end “A” plug assembly 18 includes cable end “A” plug housing 22, boot 38, IPCs 40, and cable 28. Boot 38 is not necessary to the functionality of cable end “A” plug assembly 18, but it can be utilized by customers for added strain relief and bend radius control.

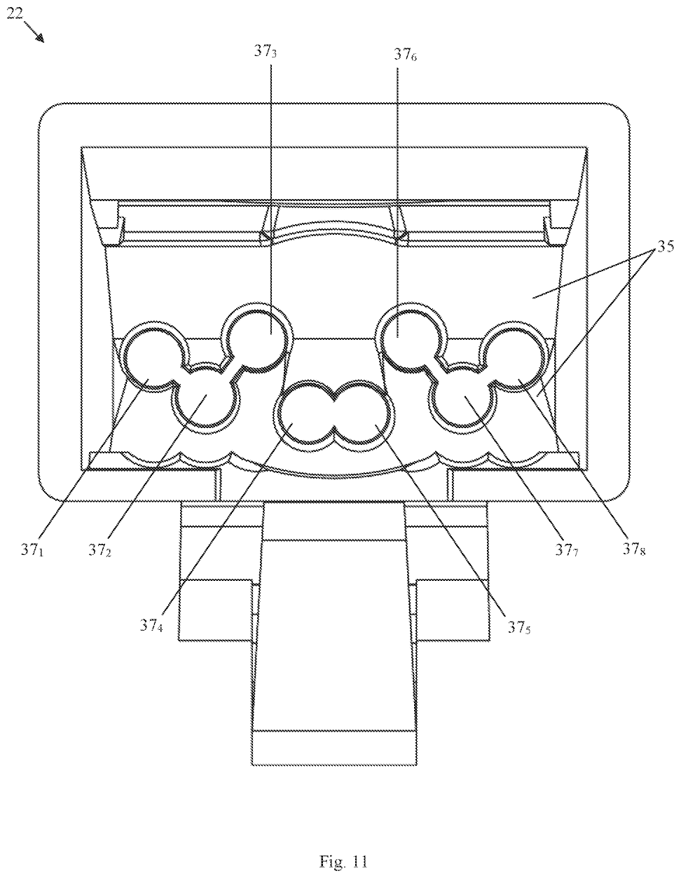

FIG. 11 is a rear view of cable end “A” plug housing 22. Cable end “A” plug housing 22 is designed to separate conductor pairs 24 without the use of additional components. Sloped surfaces 35 guide conductor pairs 24 to their respective tunnels 37 prior to termination. Tunnels 37 are oriented such that conductor pair 24₃₋₆ will route to the top and conductor pair 24₄₋₅ will route to the bottom. Tunnels 37 subscript denotes conductor numbers. This orientation of tunnels 37 allows for no crossed conductor pairs 24 when terminating end “A” of cable 28 which aids in electrical performance. For conductor pairs 24 to route to their correlating tunnels 37, conductor pairs 24 need to be prepared and trimmed prior to insertion into cable end “A” plug housing 22.

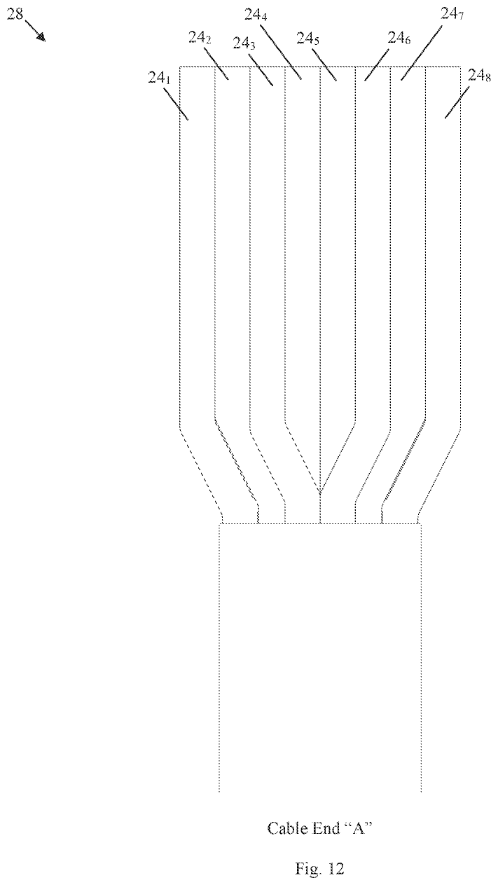

FIG. 12 is a top view of cable 28 prior to termination to cable end “A” plug assembly 18 where conductor pairs 24 have been arranged in sequence and trimmed to length. Tunnels 37 on cable end “A” plug housing 22 are identical, but inversely staggered compared to tunnels 36 on cable end “B” plug housing 20. For example, tunnel 361 in cable end “B” plug housing 20 and tunnel 372 in cable end “A” plug housing 22 are located at the same distance from the top face of the plug. As a result, IPCs 40 can be used in both cable end “B” plug assembly 16 and cable end “A” plug assembly 18. The varying height IPCs 40 are arranged in a different order for cable end “B” plug housing 20 and cable end “A” plug housing 22 to accommodate the inversely staggered heights of tunnels 36 in cable end “B” plug housing 20 and tunnels 37 in cable end “A” plug housing 22.

It should be reasonably understood by a person in the field of engineering plug design, the electrical performance of cable end “B” plug assembly 16 and cable end “A” plug assembly 18 can be adjusted by modifying pair to pair crosstalk through rational means including, but not limited to, changing surface area of IPCs 40, moving tunnels 36 and tunnels 37, and modifying the length of tunnels 36 and tunnels 37 for individual conductor pairs 24.

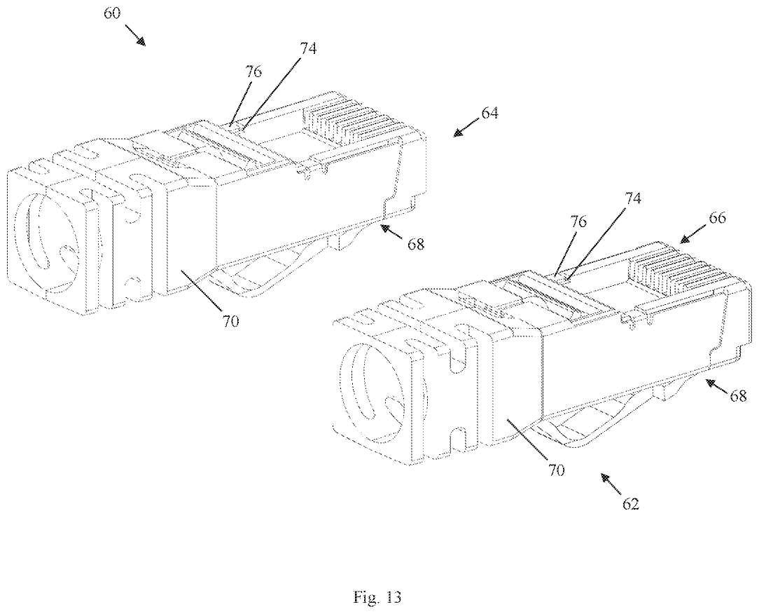

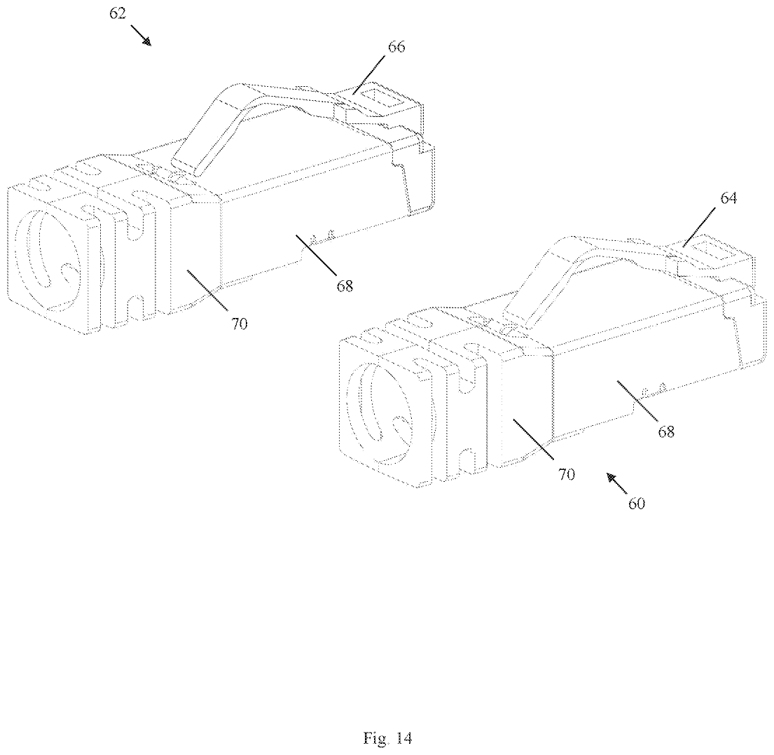

The single piece Cat6/6A plug design can be used in shielded applications as well. FIG. 13 is an isometric view of cable end “B” shielded plug assembly 60 and cable end “A” shielded plug assembly 62. FIG. 14 is a rotated isometric view of cable end “B” shielded plug assembly 60 and cable end “A” shielded plug assembly 62.

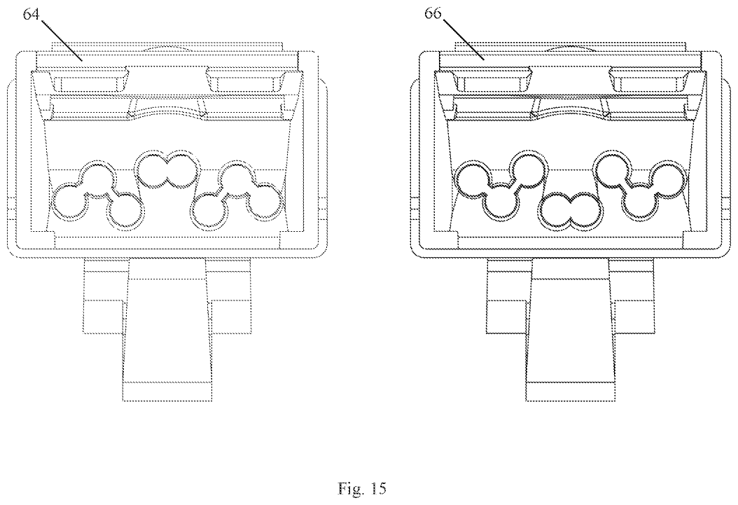

FIG. 15 is a rear view of cable end “B” shielded plug housing 64 and cable end “A” shielded plug housing 66. Cable end “B” shielded plug housing 64 and cable end “A” shielded plug housing 66 have the same functionality as cable end “B” plug housing 20 and cable end “A” plug housing 22, but their geometry has been modified to accommodate shield wrap 68 and the larger diameter shielded cable. Shield wrap 68 incorporates the beneficial features of the shielded connector design described in U.S. Pat. No. 9,431,770.

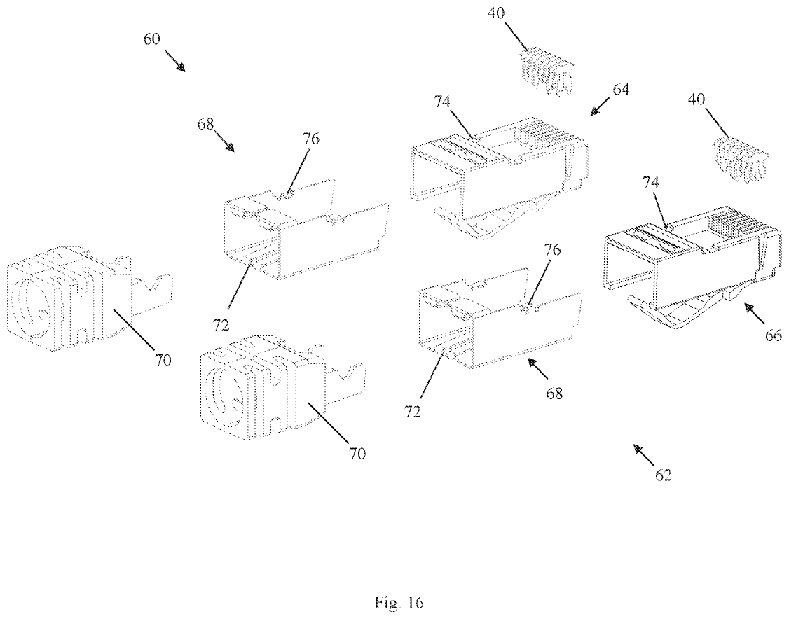

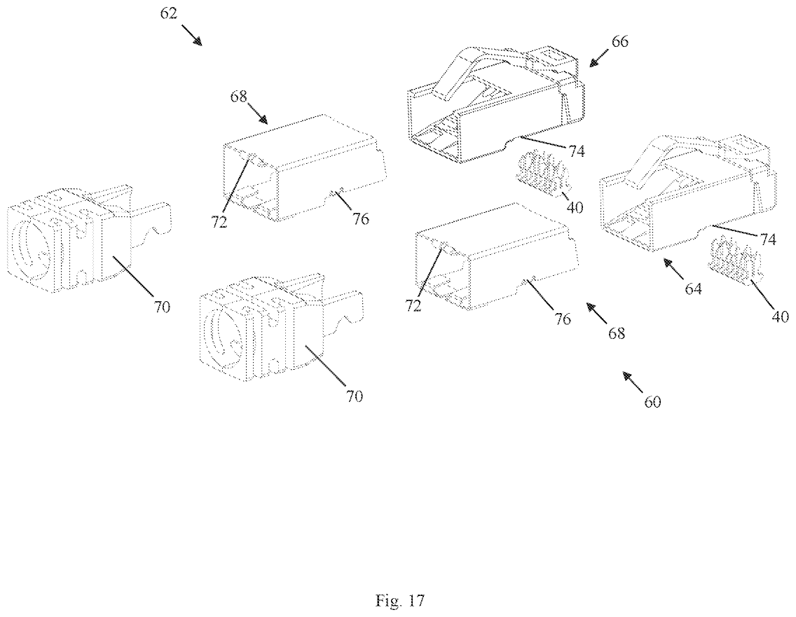

FIG. 16 is an exploded view of cable end “B” shielded plug assembly 60 and cable end “A” shielded plug assembly 62. FIG. 17 is a rotated exploded view of cable end “B” shielded plug assembly 60 and cable end “A” shielded plug assembly 62. Cable end “B” shielded plug assembly 60 includes cable end “B” shielded plug housing 64, IPCs 40, shield wrap 68, and boot 70. Boot 70 is not necessary to the functionality of cable end “B” shielded plug assembly 60, but it can be utilized by customers for added strain relief and bend radius control. Boot 70 has a larger opening for wider diameter shielded cable but has all the same functionality as boot 38 described above. Cable end “B” shielded plug assembly 60 utilizes the same IPCs 40 as Cable end “B” plug assembly 16 described above.

Cable end “A” shielded plug assembly 62 includes cable end “A” shielded plug housing 66, IPCs 40, shield wrap 68, and boot 70. Boot 70 is not necessary to the functionality of cable end “A” shielded plug assembly 62, but it can be utilized by customers for added strain relief and bend radius control. Boot 70 could be utilized with cable end “B” plug housing 20 or cable end “A” plug housing 22 if a customer were terminating a larger diameter cable. Cable end “A” shielded plug assembly 62 utilizes the same IPCs 40 as cable end “A” plug assembly 18 described above. Slot 72 in shield wrap 68 is designed to help align and contact the drain wire of a shielded cable during the plug termination process. Flanges 76 of shield wrap 68 are formed in the manufacturing process to fit inside reliefs 74 in cable end “B” shielded plug housing 64 and cable end “A” shielded plug housing 66 to help secure shield wrap 68 in place.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An RJ45 plug assembly comprising:
a communications cable having a plurality of twisted pairs of conductors; and
a housing, the housing having a plurality of sloped surfaces such that when conductors of the communications cable are straightened and aligned prior to insertion into the housing, the sloped surfaces route a first pair of conductors to a top of the housing and a second pair of conductors to a bottom of the housing.

2. The RJ45 plug assembly of claim 1, wherein the communications cable comprises four twisted pairs of conductors and when the pairs of conductors are straightened and aligned prior to insertion into the housing, the conductors, if numbered from 1 to 8 sequentially, conductors 4 and 5 would form the first pair of conductors and conductors 3 and 6 would form the second pair of conductors.

3. The RJ45 plug assembly of claim 1, wherein the communications cable comprises four twisted pairs of conductors and when the pairs of conductors are straightened and aligned prior to insertion into the housing, the conductors, if numbered from 1 to 8 sequentially, conductors 3 and 6 would form the first pair of conductors and conductors 4 and 5 would form the second pair of conductors.

4. The RJ45 plug assembly of claim 1, further comprising a boot.

5. The RJ45 plug assembly of claim 4, wherein the boot comprises notches to aid in securing the boot to the housing.

6. The RJ45 plug assembly of claim 1, further comprising a plurality of jack interface contacts.
